(19) United States
(12) Patent Application Publication
(10) Pub. No.: US 2020/0139454 A1
(43) Pub. Date: May 7, 2020

(54) Method to Make a Reusable Liquid Metal Castable Drill Bushing

(71) Applicants: Matthew Ignarski, Robbinsville, NJ (US); Jonathan Vezzosi, Toms River, NJ (US); Jason Burns, Cinnaminson, NJ (US)

(72) Inventors: Matthew Ignarski, Robbinsville, NJ (US); Jonathan Vezzosi, Toms River, NJ (US); Jason Burns, Cinnaminson, NJ (US)

(73) Assignee: United States of America as represented by the Secretary of the Navy, Patuxent River, MD (US)

(21) Appl. No.: 16/722,689

(22) Filed: Dec. 20, 2019

Related U.S. Application Data
(62) Division of application No. 15/653,605, filed on Jul. 19, 2017.

(51) Int. Cl. B23B 49/02; B22D 19/10

(52) U.S. Cl. CPC B23B 49/023; B23B 2228/21; B23B 2215/04; B22D 19/10

(57) ABSTRACT

The method of locating hole features so that old components can be replaced with new components and still match fit with the airframe includes the steps of adhering a bushing assembly into a fixture plate, rigidly attaching the fixture plate with the bushing assembly to the old component, heating the liquid metal above the liquid metal melting temperature such that the cylindrical drill bushing can move within the assembly, inserting an alignment pin within the cylindrical drill bushing such that the alignment pin is also inserted into an existing hole in the old component and the airframe, allowing the liquid metal to re-solidify; removing the alignment pin from the old component, replacing the old component with the new component, and using the re-solidified assembly as a drill guide for replacing holes in the new component.

### CROSS-REFERENCES

The present application is a divisional of application Ser. No. 15/653,605, filed Jul. 19, 2017, entitled “Reusable Liquid Metal Castable Drill Bushing Assembly and Method,” currently pending (attorney docket number PAX 207). This application is incorporated herein by reference.

### STATEMENT OF GOVERNMENT INTEREST

The invention described herein may be manufactured and used by or for the Government of the United States of America for governmental purposes without payment of any royalties thereon or therefor.

### BACKGROUND

The F-18 aircraft is currently undergoing a service life extension program (SLEP) due to total flight hour requirement changing from 6,000 hours to 10,000 hours per airframe. Certain high stress/high fatigue/high failure components are required to be replaced to prevent future catastrophic failure of aircraft. This task requires locating hole features on an aircraft when an old component is being removed due to age and a new component is replacing it. The new component must have holes placed into it in the exact same location and orientation as the original component. This is because the component being replaced will interface with several other pieces of the aircraft structure, such as the wing skin or internal ribs in an overlapping structure. Because of the imprecise nature of aircraft hole structure, the holes to attach the new component cannot be drilled beforehand. Historically, the existing holes can deviate from the blueprint location +/−0.030 inches or more. Hence, the need to duplicate the existing hole pattern precisely.

The method currently used includes rigidly clamping a potting fixture (which is defined as, but without limitation, as a plate with over-sized holes) to the aircraft, and “potting” the drill bushings or rigidly attaching the drill bushings to the fixture. The drill bushings are located using alignment pins in the existing hole locations and then rigidly attached using a “potting material,” such as hard plaster. This allows the potting fixture to duplicate the existing hole pattern precisely, no matter how much it deviates from the blueprint dimensions. The old method to pot the drill bushing to the fixture plate involves using a plaster like material, typically, HYDRACAL® white gypsum cement. The cement must be premixed to a certain consistency, which involves mixing a proportion of powder and water. If the consistency is not right, the mix could be too watery and not fill the gap properly. Or if it is not mixed enough, the HYDRACAL® cement may not fully flow into the required area and cause a poor mechanical lock.

Once all the drill bushings are potted using the HYDRACAL® cement, it must be allowed to dry for several hours. If the cement is not allowed to dry fully before the fixture is removed, the drill bushings may move and the process will need to be started over. Additionally, once the drill bushings have been used to drill out the new holes in the new component, the HYDRACAL® cement must now be removed from the potting fixture in order for the fixture to be used again. The HYDRACAL® cement hardens to a concrete like consistency, which requires it to be beat out of the existing fixture. Then a die grinder must be used to clean out any remaining HYDRACAL® cement in the fixture plate, which can take several hours/days. In the past, another liquid metal called Wood's metal or Cerrobend (a eutectic alloy of bismuth, lead, tin, and cadmium) was used. The composition includes lead and cadmium which are toxic materials; therefore, the composition is no longer used for toxicity reasons and safety issues arising from handling this metal in the liquid state at relatively high temperatures.

In an effort to save time and skip steps such as removing the wing from the aircraft, repairs are being attempted to the bottom of the wing, while the wing remains attached. This potting material does not work in an upside down configuration because it will leak out before setting. Therefore, a new apparatus and method for replacing holes is needed.

### SUMMARY

The present invention is directed to a reusable liquid metal castable drill bushing assembly and method with the needs enumerated above and below.

The present invention is directed to a reusable liquid metal castable drill bushing assembly for use in a fixture plate, which includes a cylindrical sleeve having an inner diameter, a cylindrical drill bushing having an outer diameter, a liquid metal disposed between the outer diameter of the cylindrical drill bushing and the inner diameter of the cylindrical sleeve, a seal disposed on the cylindrical sleeve, the cylindrical drill bushing, and the liquid metal such that the seal retains the liquid metal between the outer diameter of the cylindrical drill bushing and the inner diameter of the cylindrical sleeve.

It is a feature of the present invention to provide a non-toxic apparatus and method to locate position and angle of feature holes on a work piece, particularly on an aircraft.

It is a feature of the present invention to provide a reusable liquid metal castable drill bushing assembly and method that can be utilized in an upside down configuration.

It is a feature of the present invention to provide a reusable liquid metal castable drill bushing assembly and method that has little set up time and can be used and reused quickly, neatly, and safely.

### DRAWINGS

These and other features, aspects and advantages of the present invention will become better understood with reference to the following description and appended claims, and accompanying drawings wherein:

FIG. 1A is a perspective view of the drill bushing assembly;

FIG. 1B is a side view of the drill bushing assembly;

FIG. 1C is a cross-sectional view of the drill bushing assembly;

FIG. 2 is perspective view of the drill bushing assembly in use; and

FIG. 3 is an exploded perspective view of the drill bushing assembly in use.

### DESCRIPTION

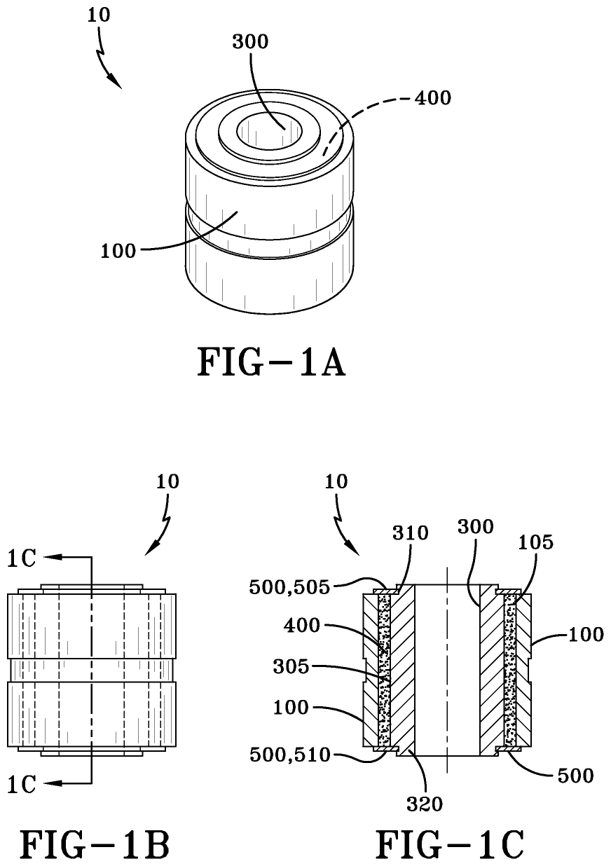

The preferred embodiments of the present invention are illustrated by way of example below and as shown in FIGS. 1A-C, 2 and 3. As shown in FIGS. 1A, 1B, and 1C, the reusable liquid metal castable drill bushing assembly 10 for use in a fixture plate 40 includes a cylindrical sleeve 100 having an inner diameter 105, a cylindrical drill bushing 300 having an outer diameter 305, a liquid metal 400 disposed between the outer diameter 305 of the cylindrical drill bushing 300 and the inner diameter 105 of the cylindrical sleeve 100, a seal 500 disposed on the cylindrical sleeve 100, the cylindrical drill bushing 300, and the liquid metal 400 such that the seal 500 retains the liquid metal 400 between the outer diameter 305 of the cylindrical drill bushing 300 and the inner diameter 105 of the cylindrical sleeve 100.

In the description of the present invention, the invention will be discussed in a military aircraft environment; however, this invention can be utilized for any type of application that requires locating hole features.

In the preferred embodiment, the liquid metal 400 is a fusible alloy of bismuth, indium, and tin. It may be Field's metal, also known as Field's alloy, which is a fusible alloy that becomes liquid at approximately 62° C. (144° F.). It is a eutectic alloy of bismuth, indium, and tin. Alternatively, any material that can change from liquid to solid phase based on an exterior input may be utilized, such as, but without limitation, magneto resistive fluid.

In one of the embodiments of the invention, the cylindrical drill bushing 300 may be manufactured from existing potted drill bushings, while the cylindrical sleeve 100 may be the inner diameters of the cylindrical holes in the fixture plate 40 (or potting fixture) as manufactured from a machinable phenolic plate such as Garolite. The seal 500 may be a rubber seal, or any other material that is practicable in the design to allow maximum flexibility for positional and angular movement of cylindrical drill bushing 300 within the cylindrical sleeve 100 while maintaining a reliable seal.

In the preferred embodiment, there are two seals 500, a top seal 505 corresponding to the top 310 of the cylindrical drill bushing 300 and a bottom seal 510 corresponding to the bottom 320 of the cylindrical drill bushing 300. The top seal 505 and the bottom seal 510 may be formed to the cylindrical drill bushing 300 by over-molding and may be mechanically clamped or bonded to the cylindrical sleeve 100 such that the liquid metal 400 is retained between the cylindrical drill bushing 300 and the cylindrical sleeve 100.

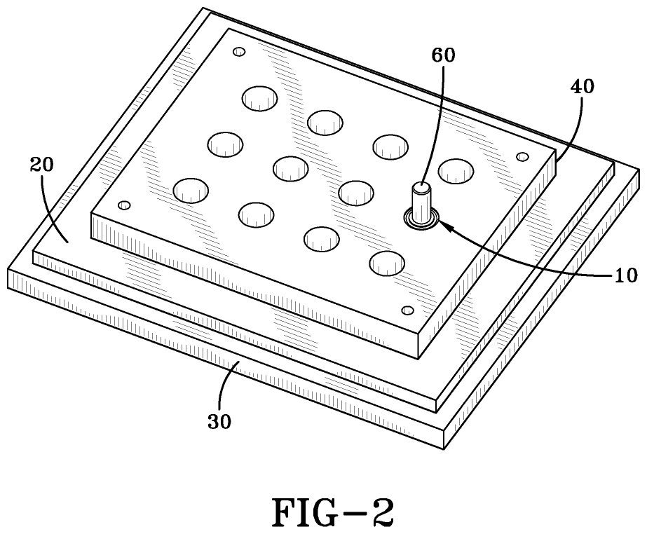

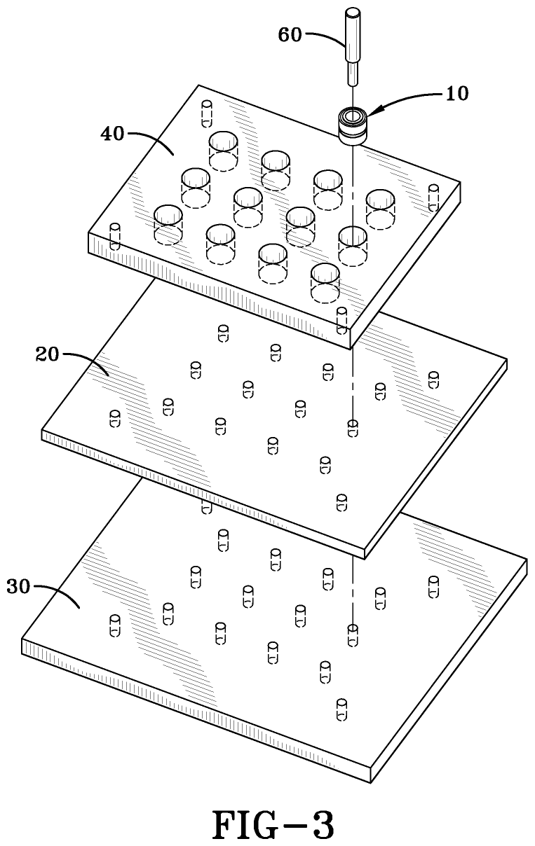

As shown in FIGS. 2 and 3, the method of locating hole features so that old components 20 (which are attached to the airframe 30) can be replaced with new components (not shown) and still match fit with the airframe 30 (or any other frame or structure) includes the steps of adhering a bushing assembly (specifically the reusable liquid metal castable drill bushing assembly 10 described above) into a fixture plate 40, rigidly attaching the fixture plate 40 with the bushing assembly 10 to the old component (or work piece) 20, heating the liquid metal 400 above the liquid metal melting temperature such that the cylindrical drill bushing 300 can freely move within the assembly 10, inserting an alignment pin 60 within the cylindrical drill bushing 300 such that the alignment pin 60 is also inserted into an existing hole in the old component 20 and the airframe 30, allowing the liquid metal 400 to cool and re-solidify; removing the alignment pin 60 from the old component 20, replacing the old component 20 with the new component, and using the re-solidified assembly as a drill guide for replacing holes in the new component.

The bushing assembly 10 may be adhered to the fixture plate 40 using cyanoacrylate glue, or any fastener practicable. In an alternate embodiment, the bushing assembly is disposed within the potting fixture with the potting fixture serving as the cylindrical sleeve 100.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A method of locating hole features so that old components can be replaced with new components, the method comprising:
adhering or building a bushing assembly into a fixture plate, the bushing assembly comprising:
a cylindrical sleeve having an inner diameter;
a cylindrical drill bushing having an outer diameter, the cylindrical drill bushing disposed within the cylindrical sleeve;
a liquid metal disposed between the inner diameter of the cylindrical sleeve and the outer diameter of the cylindrical drill bushing;
a seal disposed on the cylindrical sleeve, the cylindrical drill bushing, and the liquid metal such that the seal retains the liquid metal between the outer diameter of the cylindrical drill bushing and the inner diameter of the cylindrical sleeve;
rigidly attaching the fixture plate with the bushing assembly to an old component;
heating the liquid metal above the liquid metal melting temperature such that the cylindrical drill bushing can move within the bushing assembly;
inserting an alignment pin within the cylindrical drill bushing such that the alignment pin is also inserted into an existing hole in the old component;
allowing the liquid metal to re-solidify; and,
using the assembly as a drill guide for replacing holes in a new work component.
